(19) United States
(12) Patent Application Publication
(10) Pub. No.: US 2026/0018804 A1
(43) Pub. Date: Jan. 15, 2026

(54) LEAKY WAVE BASED DUAL POLARIZED HOLOGRAPHIC ANTENNA DESIGN FOR LOW COMPLEXITY JOINT PHASED TIME ARRAY INTEGRATION

(71) Applicant: Samsung Electronics Co., Ltd., Suwon-si (KR)

(72) Inventors: Aditya Dave, Plano, TX (US); Won Suk Choi, McKinney, TX (US); Shenggang Dong, Dallas, TX (US); Navneet Sharma, Allen, TX (US); Gang Xu, Allen, TX (US); Jianzhong Zhang, Dallas, TX (US)

(21) Appl. No.: 19/069,189

(22) Filed: Mar. 3, 2025

Related U.S. Application Data
(60) Provisional application No. 63/671,699, filed on Jul. 15, 2024.

(51) Int. Cl. H01Q 25/00; H01Q 3/34; H01Q 5/314; H04B 7/0426

(52) U.S. Cl. CPC H01Q 25/001; H01Q 3/34; H01Q 5/314; H04B 7/043

(57) ABSTRACT

Joint phase time array transmission employs dual polarized holographic beamforming antenna rather than phased array antenna. Every antenna element including an array of holographic beamforming unit cells requires only a single power amplifier between the antenna element and a corresponding delay element. Dual polarization is provided by antenna tiles each with parallel arrays of horizontal slot holographic beamforming unit cells rotated relative to each other, or by antenna elements of 45° slot holographic beamforming unit cells alternated on an antenna panel with 135° slot holographic beamforming unit cells. Improvements in transmit power and efficiency are achieved over joint phase time array transmission with phased array antenna, with fewer phase shifters and other active components per beam steering antenna element.

### CROSS-REFERENCE TO RELATED AND CLAIM OF PRIORITY

The present application claims priority under 35 U.S.C. § 119(e) to U.S. Provisional Patent Application No. 63/671,699 filed on Jul. 15, 2024, which is hereby incorporated by reference in its entirety.

### TECHNICAL FIELD

The present disclosure relates generally to beamforming antenna design and, more specifically, to design of holographic beamforming antennas for joint phased time array operation.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to holographic beamforming antenna design for joint phased time array operation.

In a first embodiment, a method includes constructing a one-dimensional array of a number of unit cells each having unit cell layout with a resonance frequency meeting a requirement for leaky wave antenna operation of a dual polarized holographic beamforming antenna. The method also includes determining that a load attenuation for the one-dimensional array meets one or more efficiency requirements. The method further includes determining one or more parameters including capacitance for achieving a desired beamforming steering range and a desired beamforming steering resolution with the one-dimensional array. The method still further includes scaling the one-dimensional array to form a two-dimensional, dual polarized holographic beamforming antenna.

In a second embodiment, an apparatus includes a first holographic beamforming antenna element having a first polarization, the first holographic beamforming antenna element including a linear array of two or more first holographic beamforming unit cells. The apparatus also includes a second holographic beamforming antenna element having a second polarization different than the first polarization, the second holographic beamforming antenna element including a linear array of two or more second holographic beamforming unit cells. The apparatus further includes a single first power amplifier configured to amplify signals to each of the first holographic beamforming unit cells within the first holographic beamforming antenna element. The apparatus still further includes a single second power amplifier configured to amplify signals to each of the second holographic beamforming unit cells within the second holographic beamforming antenna element. The first holographic beamforming antenna element and the second holographic beamforming antenna element are configured to transmit separate beams.

In a third embodiment, an apparatus includes a joint phased time array transmit circuit including a first power amplifier, a second power amplifier, a first delay element, and a second delay element. The first power amplifier is configured to amplify a single first signal based on an output of the first delay element and the second power amplifier is configured to amplify a single second signal based on an output of the second delay element. The apparatus also includes a first holographic beamforming antenna element having a first polarization, the first holographic beamforming antenna element including a linear array of two or more first holographic beamforming unit cells each configured to receive the single first signal. The apparatus further includes a second holographic beamforming antenna element having a second polarization different than the first polarization, the second holographic beamforming antenna element including a linear array of two or more second holographic beamforming unit cells each configured to receive the single second signal. The joint phased time array transmit circuit is configured to transmit a plurality of separate beams using the first holographic beamforming antenna element and the second holographic beamforming antenna element.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network within which dual polarized holographic antenna may be implemented according to embodiments of the present disclosure;

FIG. 2 illustrates an example gNB within which dual polarized holographic antenna may be implemented according to embodiments of the present disclosure;

FIG. 3 illustrates an example UE for use with a communication system within which dual polarized holographic antenna may be implemented according to embodiments of the present disclosure;

FIG. 4A and FIG. 4B illustrate an example of wireless transmit and receive paths according to embodiments of the present disclosure;

FIG. 5 illustrates a flowchart of an example procedure for decoding of low-density parity check codes according to embodiments of the present disclosure;

FIGS. 6A and 6B collectively illustrate an example procedure for designing a holographic beamforming antenna array according to embodiments of the present disclosure;

FIG. 7A illustrates a 1D array of single polarization antenna unit cells, while FIG. 7B illustrates two 1D arrays each of single polarization antenna unit cells;

FIG. 8 illustrates a dual polarization holographic beamforming antenna array design according to embodiments of the present disclosure;

FIGS. 9A and 9B illustrate two alternative dual polarization holographic beamforming antenna array designs according to embodiments of the present disclosure;

FIG. 10A illustrates a generic holographic beamforming element, and FIG. 10B illustrates the resulting radiation pattern for three frequencies;

FIG. 11A illustrates a generic holographic beamforming element, and FIG. 11B shows the resulting radiation pattern for three frequencies;

FIG. 12 illustrates a block diagram for a generalized JPTA antenna panel in transmitting mode;

FIG. 13 depicts a dual polarization holographic beamforming antenna architecture for use with joint phased time array operation in accordance with this disclosure;

FIGS. 14A and 14B comparatively illustrate a traditional FR2 antenna array architecture versus a subarray-based implementation;

FIG. 15 illustrates a JPTA system architecture;

FIGS. 16A and 16B illustrate achievable behavior with JPTA based beamforming;

FIG. 17 illustrates operation of a holographic beamforming antenna;

FIG. 18 shows a plan view of one row of a holographic antenna with horizontal polarization;

FIG. 19 is a sectional view of the stack for a portion of the structure in FIG. 18; and

FIG. 20 illustrate steer angles achievable with a holographic antenna as shown in FIG. 18.

### DETAILED DESCRIPTION

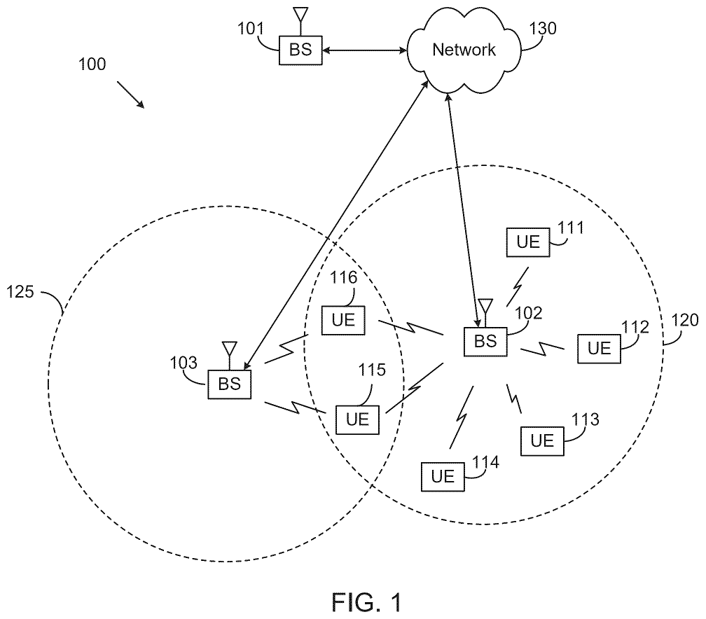

FIGS. 1-9B and 13, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following documents and standards descriptions are hereby incorporated by reference into the present disclosure as if fully set forth herein:
[1] H-C. Park et al., “4.1 A 39 GHZ-Band CMOS 16-Channel Phased-Array Transceiver IC with a Companion Dual-Stream IF Transceiver IC for 5G NR Base-Station Applications,” 2020 IEEE International Solid-State Circuits Conference—(ISSCC), San Francisco, CA, USA, 2020, pp. 76-78.

The following textbook provides general background information on leaky-wave antennas:
[2] C. Caloz, D. R. Jackson, and T. Itoh, “Leaky-wave antennas,” in Frontiers in Antennas: Next Generation Design & Engineering. New York: McGraw-Hill, December 2011.

Analog beamforming system has been widely used in the wireless communication systems to overcome excessive path loss. The challenge for the analog beamforming system is that beamforming is achieved in the time domain. Therefore, typically only one beam can be formed at a time. This limits the beam pairing and beam tracking capability when multiple users are in the cell to be connected to the base station at the same time, due to the beam switching overhead. Also, the uplink is challenging in a time division duplex (TDD) system because the UE only gets allocated in a short period of time to transmit.

A multi-beam system using joint-phased time array (JPTA) technology has been proposed in, for example, U.S. Pat. No. 12,199,724. A scalable design for two-dimensional (2-D) operation of a JPTA has been proposed in, for example, U.S. Patent Application Publication No. 2024/0313398. The key technologies in those proposals relate to the use, in the joint phase time array approach, of delay line integrated circuits to combine different antenna inputs, with delay line integrated circuits (ICs) employed to establish a combined intermediate frequency (IF). When antenna inputs along the vertical direction are combined, JPTA-based beam spreading behavior is seen in the azimuth. When antenna inputs along the horizontal direction are combined, beam spreading is seen the elevation direction.

One major requirement for the architecture in the above-referenced proposals is presence of delay-line ICs that are driven with a power amplifier (PA) in the transmit path or a low noise amplifier (LNA) in the receive path for each antenna element. The requirement is necessitated by the need for antenna element spacing of one-half wavelength (0.5λ) or closer. Hence the number of PAs and/or LNAs cannot be reduced using a sub-array architecture, since a larger sub-array size will violate JPTA operation in one or more directions.

The present disclosure utilizes uses holographic beamforming (HBF) techniques to enable JPTA operation with a reduced number of PAs. Holographic beamforming is based on a guided wave approach. Each long transmission line along the horizontal or vertical direction comprises small radiating elements, so that the inherently long antenna length requires a smaller number of PAs in the antenna panel and complexity of passive elements like power divider is reduced. The architecture described below also enables use of a significantly smaller number of active elements for seamless JPTA operation in one direction.

For millimeter wave (mmWave) systems, it is necessary to increase the effective isotropic radiated power (EIRP) to increase the coverage range of base stations and make the FR2 band product more viable. The EIRP on the transmit side is proportional to Pt*Gt, where Pt is output power of the power amplifiers and Gt is the gain of the antenna array. Hence EIRP can be increased in two ways: by increasing the power amplifier power; or by increasing the gain of the antenna array. The latter is achieved by using larger antenna panel with more elements. However, base station solutions are typically limited by panel area and cannot be increased above a certain limit. Hence the best possible way is to increase Pt is by using high-power PAs. There are two main implementation challenges for this:
1. High power PAs are costlier. If each traditional power amplifier is replaced with a high-power power amplifier, the overall system cost becomes unviable to implement.
2. High power PAs occupy larger size. It is not possible to replace a traditional complementary metal oxide semiconductor (CMOS) power amplifier with a high-power gallium nitride/gallium arsenide (GaN/GaAs) power amplifier since the footprint for the latter is much larger.

To overcome the above challenges, it is necessary to employ architectures that can use fewer power amplifiers without sacrificing beam steering performance of the system. A practical way to reduce the number of power amplifiers is the use of subarrays. In this architecture, one power amplifier output is divided to multiple antennas by use of a power divider. However, for really large antenna array lengths, it is necessary to have complex power divider implementations that incur large transmission losses. Furthermore, a power divider antenna array typically supplies all antenna elements with the same magnitude and phase of the radio frequency (RF) signal. For maintaining beam steerability as traditional one power amplifier per element system, it is necessary for each antenna element to have independent phase control.

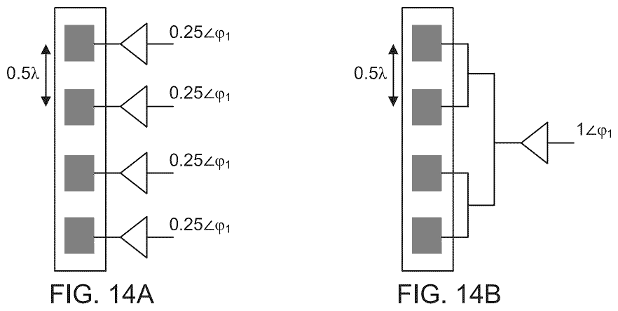

FIGS. 14A and 14B show a traditional FR2 antenna array architecture (FIG. 14A) with one power amplifier per element versus the subarray-based implementation (FIG. 14B) that restricts magnitude and phase control for each element. To avoid complex power dividers and associated losses for long antenna sub-arrays, it is necessary to employ architectures where antenna length is larger and no subarray is required.

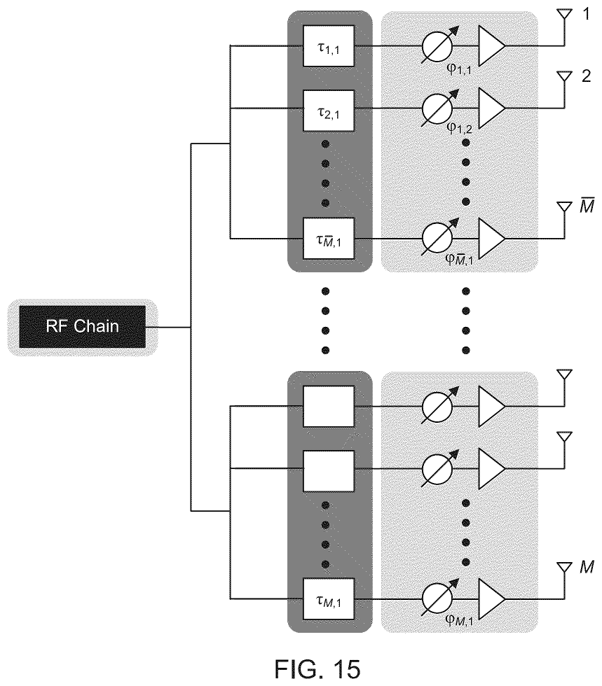

Millimeter wave base stations employ the phased-array technology to achieve high beamforming gain to overcome the excessive path loss. TDD systems rely on time division multiplexing of the downlink and uplink traffic of multiple users through separate time slots. FIG. 15 shows a JPTA system architecture as described, together with associated performance benefits, in U.S. Patent No. 12,199,724.

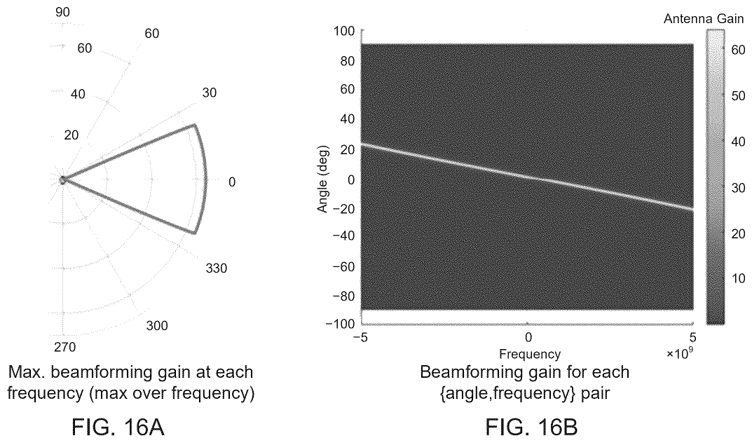

Simultaneous service can be provided for several users in a localized region with the full beamforming gain or in scenarios where link reliability and easy beam-tracking are desired, or where fast initial beam-alignment is desired. Such a beam behavior can be obtained using the JPTA architecture as shown in FIG. 15. In this architecture, the number of phase shifters and number of delay elements are both set to M. Antenna m is designed to have a delay variation between τ_{m,1}∈[0, (m−1)sin(Δθₘₐₓ)/W], where W is the system bandwidth and Δθₘₐₓ is the maximum desired beam-sway in one direction of the center angle. As an example, the achievable antenna gain for a transmitter (TX) with a half-wavelength spaced uniform linear array with M=N=64, θ₁=0 and Δθ₁=π/8 is illustrated in FIGS. 16A and 16B. As can be seen from FIGS. 16A and 16B, the design can achieve the desired frequency dependent beam pattern.

In the JPTA based architecture, for each angle in the vicinity of θ₁, there is a unique frequency region where the peak beamforming gain is obtained. Thus in fast user mobility scenarios, by observing the frequency or sub-carrier where the highest signal power is obtained, the receiver can estimate the best beam direction or the required beam correction to be used at the transmitter. Therefore fast beam alignment can be achieved using this architecture. Furthermore, as the user moves away by more than a 3 decibel (dB) beamwidth on one frequency, the signal-to-noise ratio (SNR) does not completely fall to zero on the whole band. Rather, the maximum beamforming gain shifts to a different frequency. This can be beneficial since that beamforming gain shift can provide a smooth degradation of service with user mobility and does not cause sudden outage as in the case of frequency-flat beamforming.

It is also noted that in the cell-edge case, the user equipment (UE) transmitter typically must boost the transmit output power for the base station to receive UE signals above the sensitivity level. However, the transmit power is bounded by regulatory and absorption rate limitations. Therefore, the UEs could be power limited. JPTA allows multiple UEs to be connected to a base station simultaneously, reducing the need for time multiplexing. This essentially allows the base station to allocate more time for the cell edge UEs through JPTA, resulting higher SNR at the receiver side to support longer range or higher data rate, or reduced UE transmit power requirement to reduce the power consumption.

However, the challenge for such implementation is that one delay element is needed for each antenna element. A large number of antennas need to be deployed in a commercial base station, typically arranged in 2-D antenna array. The dimension could be as large as 16×16, as an example. [1] In this case, 256 delay elements would be needed. This will increase the system complexity, cost and power consumption significantly. The 2-D phased-array system also requires near λ/2 spacing among the antenna elements. At mmWave frequencies, the wavelength is short. This limits the dimension of the transceiver ICs, i.e. on average, each channel needs to be smaller than λ/2 by N2 in size in order to make the 2-D array scalable. Adding the extra delay elements could violate such spacing constraints.

Solutions are needed that address both of the above-described problems: The first problem is a need for an antenna array that reduces the number of PAs while preserving the beam steering performance of the overall array in both azimuth and elevation directions. The second problem is utilizing an antenna architecture with such fewer power amplifiers to enable JPTA operation using fewer combining elements. This can enable cost-saving while leveraging superior system performance from RF front end and antenna panels that can support high EIRP base-station operation at FR2 band.

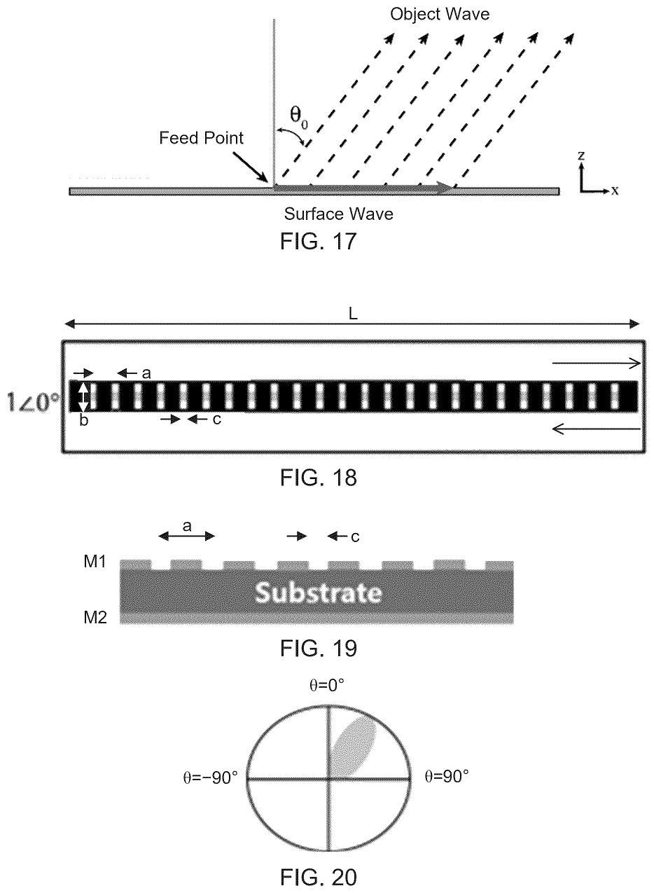

A holographic antenna is a type of antenna that uses optical holography to create a radiating aperture that is formed by a hologram, which is an interference pattern between a surface wave and a radiated plane wave. FIG. 17 illustrates operation of a holographic beamforming antenna, in which a surface wave along the length of the antenna from a feed point results in propagation of an object wave at angle θ₀, from the normal. Holographic beamforming differs from beamforming with a traditional antenna design in that the traditional antenna relies on relatively large area individual elements that are resonant at the operating frequency, while the holographic antenna has relatively tiny radiators with much higher resonance frequency, individually. At the operating frequency, the individual radiators leak energy, and all radiators together leak enough energy for the overall structure to function as an antenna. Accordingly, this approach is called a leaky wave antenna. The approach forms the basis for the holographic beamforming architecture explained in this disclosure.

FIG. 18 shows a plan view of one row of a holographic antenna with horizontal polarization. This one row can be modeled as a single antenna element comprising many small slot radiators on a microstrip line that can support a guided wave. The slots are spaced along a length L of the antenna, separated by a dimension a and each having a length b and a width c, as shown. The surface wave propagates from the feed point (on the left in FIG. 18) to the terminal end (on the right in FIG. 18). Energy reflects back from the terminal end, as shown in the diagram.

FIG. 19 is a sectional view of the stack for a portion of the structure in FIG. 18, taken along a horizontal centerline thereof. Holographic beamforming array implementations are typically formed on a single layer of substrate with two metal layers for signal and ground. The metal layer M2 in FIG. 18 is the ground layer for the holographic beamforming antenna. The metal layer M1 is where a holographic beamforming guided wave transmission line is implemented. Metal layers M1 and M2 both have a thickness t, and are separated by a height h of the substrate. The substrate height h can be between 0.01λ-0.2λ. The metal thickness t is assumed to be according to the standard printed circuit board (PCB) process as 17 microns (μm) (0.5 oz) or 35 μm (1 oz).

The antenna of FIGS. 18 and 19 is excited on the left side and supports leaky mode depending on the spacing and size of the radiators. The structure can support a fast wave or slow wave depending on the wave number of the leaky wave. A fast wave has larger phase velocity than the speed of light owing to the phase constant β of the leaky wave mode being smaller than k₀, where k₀ is the wave number in free space. If the fast wave is supported on a leaky wave antenna that comprises uniform radiators, the antenna is called quasi-uniform leaky wave antenna (LWA).

The antenna of FIGS. 18 and 19 is called a periodic LWA when the guiding structure supports a slow wave such that β<k₀. The fundamental non-radiating guided wave mode, which is quasi-transverse electromagnetic (TEM) in the case of a microstrip line, is made to radiate by introducing periodicity along the length of the structure as shown by the white rectangles that represent slots in FIG. 18. The field on this transmission line is then characterized by infinite number of space harmonics with wave number on the nth slot on the x direction given by:

$${k}_{x , n} = {k}_{x , 0} + \frac{2 π n}{p} , \qquad ( 1 )$$

where p is the periodicity of the unit cell (p=a in FIGS. 18 and 19). One advantage of the periodic LWA is that the structure can create both a forward and backward wave since β₋₁=Re(k_{x,-1}) can be either positive or negative.

Whenever a leaky wave antenna is fed at the center, the structure creates bidirectional dual-beam radiation. Since the present disclosure is currently focused on generating only one coherent beam for base-station application, edge-fed LWAs are the main subject herein. When the leaky wave antenna is fed at the edge, the radiating field or current ψ(x) has the form given by:

$$ψ ( x ) = {Ae}^{- {k}_{x} x} , \qquad ( 2 )$$

where kₓ=β−jα is the complex wave number. β>0 represents a fast wave indicated by a positive propagation constant and β<0 represents a slow wave. A determines the loss of the structure due to periodic unit cells. Most of the energy loss in the unit cells is because of radiation, hence radiation efficiency eᵣ=1−e^{-2αL} represents overall efficiency. Using close to 90% efficiency, eᵣ gives the loss due to each unit cell, which can be used to determine the unit cell leakage and resonance. Depending on the value of β, the structure can support a steer angle to the left or right as shown in FIG. 20. That is:

$$β = {k}_{0} sin ( θ ) ,$$

where θ∈[−90°, 90°]. Hence, when the beam is steered to the right side of boresight, β is positive and structure produces a forward or fast wave. When the beam is steered to the left side, β is negative and the structure produces a backward or slow wave. For steering at boresight, β is equal to zero and the structure should produce a standing wave.

To have the full steer range of −90° to +90°, it is necessary to have effective permittivity (ε_{eff}) of the quasi-TEM microstrip line ε_{eff}>0 to avoid dual beams.[2] This results in the condition for design being:

$$\frac{{β}_{0}}{{k}_{0}} > 3.$$

FIGS. 1-4 below describe various embodiments implemented in wireless communications systems and with the use of orthogonal frequency division multiplexing (OFDM) or orthogonal frequency division multiple access (OFDMA) communication techniques. The descriptions of FIGS. 1-4 are not meant to imply physical or architectural limitations to how different embodiments may be implemented. Different embodiments of the present disclosure may be implemented in any suitably arranged communications system.

FIG. 1 illustrates an example wireless network 100 within which dual polarized holographic antenna may be implemented according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for decoding of low-density parity check codes. In certain embodiments, one or more of the BSs 101-103 include circuitry, programing, or a combination thereof to support dual polarized holographic antenna.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

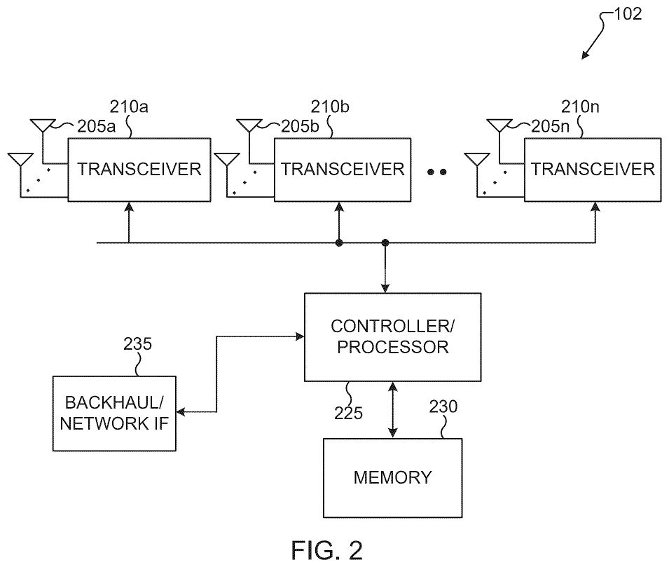

FIG. 2 illustrates an example gNB 102 within which dual polarized holographic antenna may be implemented according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for beam management in JPTA system with multiple component carriers. Any of a wide variety of other functions could be supported in the gNB 102 by the controller/processor 225.

The controller/processor 225 is also capable of executing programs and other processes resident in the memory 230, such as processes to trigger beam management in a JPTA system with multiple component carriers. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

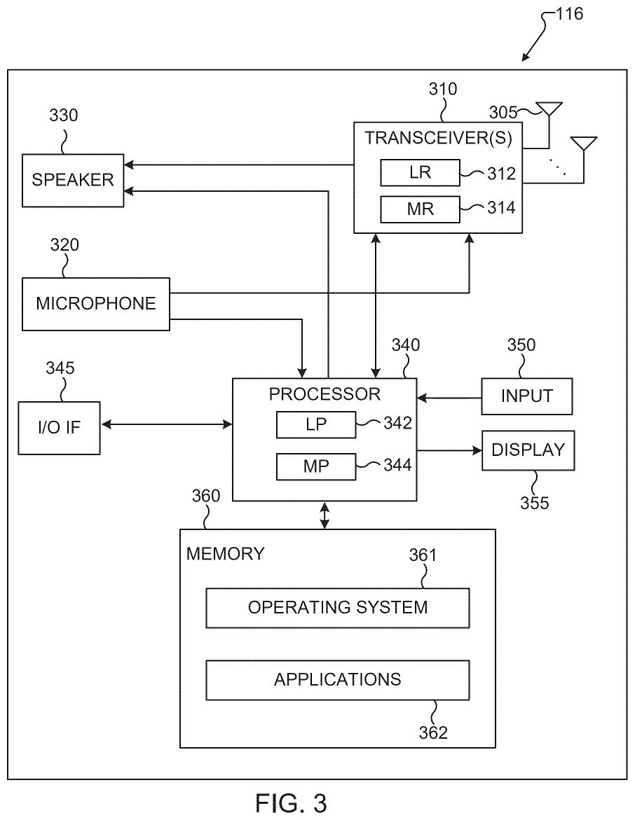

FIG. 3 illustrates an example UE 116 for use with a communication system within which dual polarized holographic antenna may be implemented according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for beam management in JPTA system with multiple component carriers as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

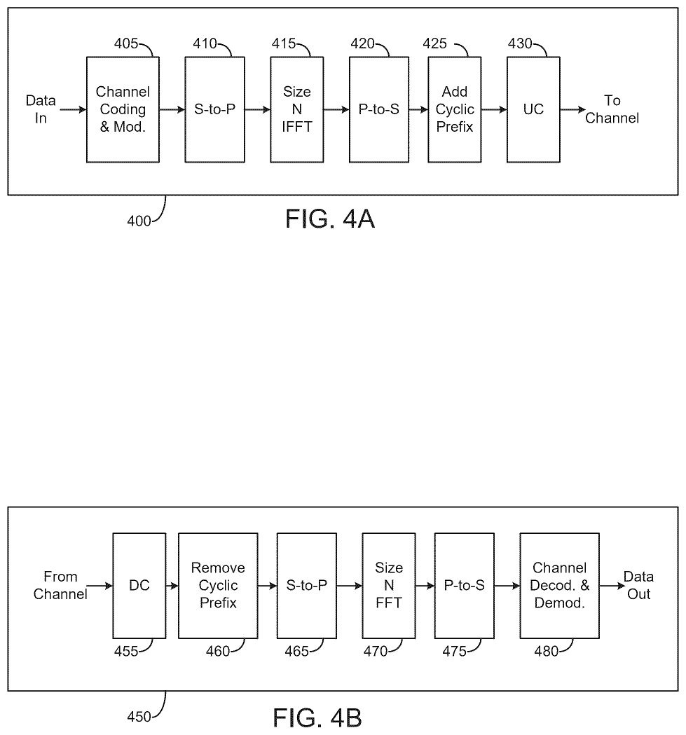

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 or the receive path 450 is configured for use with dual polarized holographic antenna as described in embodiments of the present disclosure. For example, embodiments of dual polarized holographic antenna as described herein may be implemented in connection with the channel output from up-converter 430 depicted in FIG. 4A or the channel input to down-converter 455 depicted in FIG. 4B.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 450 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of the present disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

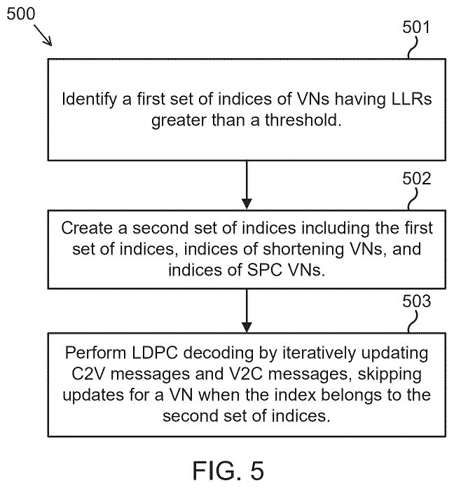

FIG. 5 illustrates a flowchart of an example procedure 500 for decoding of low-density parity check codes according to embodiments of the present disclosure. For example, procedure 600 for decoding of low-density parity check codes can be performed by the UE 116, the gNB 102, and/or network 130 in the wireless network 100 of FIG. 1. This example is for illustration only and other embodiments can be used without departing from the scope of the present disclosure.

The procedure 500 begins with identifying a first set of indices of VNs that have LLRs greater than a threshold (step 501). For example, the threshold may correspond to bit levels with the highest reliability based on mutual information between bit levels and a received signal. Probability density functions (PDFs) of LLRs may be generated for the determined bit levels, then used to incrementally increase a threshold value initialized to zero based on an average number of bits assigned to the determined bit levels with LLRs larger than the threshold and a probability of at least one bit being incorrectly recovered. A second set of indices is created (step 502), including the first set of indices, indices of shortening VNs, and indices of SPC VNs. As noted above, shortening VN are always assigned with zero, allowing the corresponding LLR to be initialized to +∞, while SPC VNs only connect to one CN. LDPC decoding is then performed by iteratively updating C2V messages and V2C messages (step 503), skipping updates for any VN when the index of that VN belongs to the second set of indices.

Although FIG. 5 illustrates one example of a procedure 500 for decoding of low-density parity check codes, various changes may be made to FIG. 5. For example, while shown as a series of steps, various steps in FIG. 5 could overlap, occur in parallel, occur in a different order, or occur any number of times (including zero times).

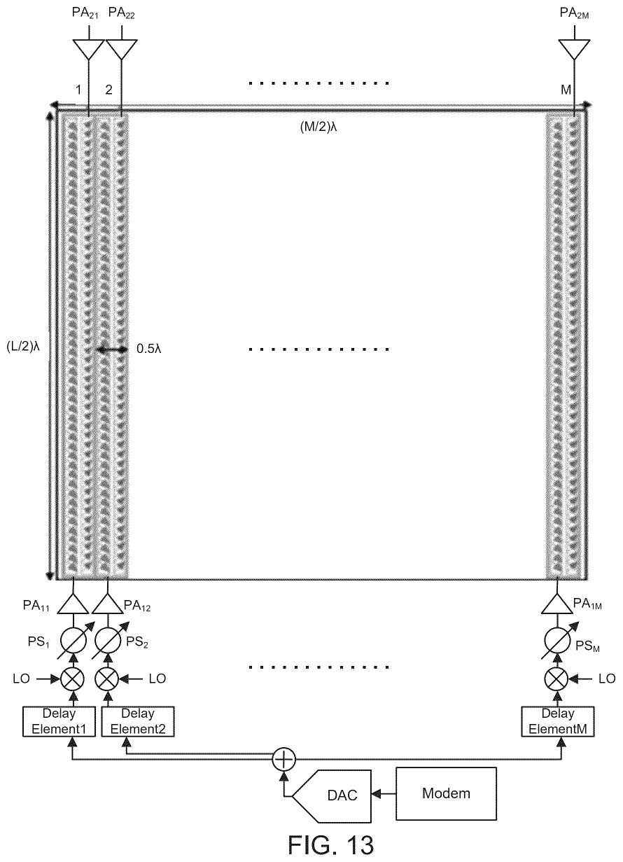

Based on the principles discussed above in connection with FIGS. 13A through 19, a unit cell of a holographic beamforming antenna based on a leaky-wave approach may be designed. The unit cell may then be used to design one dimensional (1D) finite antenna element comprising multiple unit cells arranged periodically. Tuning elements like pin diodes or varactor diodes are integrated on individual unit cells to change the values of phase constant βₙ for each of the n unit cells in the antenna element in real time. Real time change of the phase constant values enable creation of beam steering solutions using holographic antennas. Multiple 1D elements can be stacked vertically to create a two dimensional (2D) holographic beamforming antenna array. Such an array can steer the beam in azimuth and elevation directions. In some embodiments, digital beamforming is used to steer beam in azimuth or elevation direction. In other embodiments, the beamforming in both azimuth and elevation directions is fully analog using tuning elements like varactors or pin-diodes.

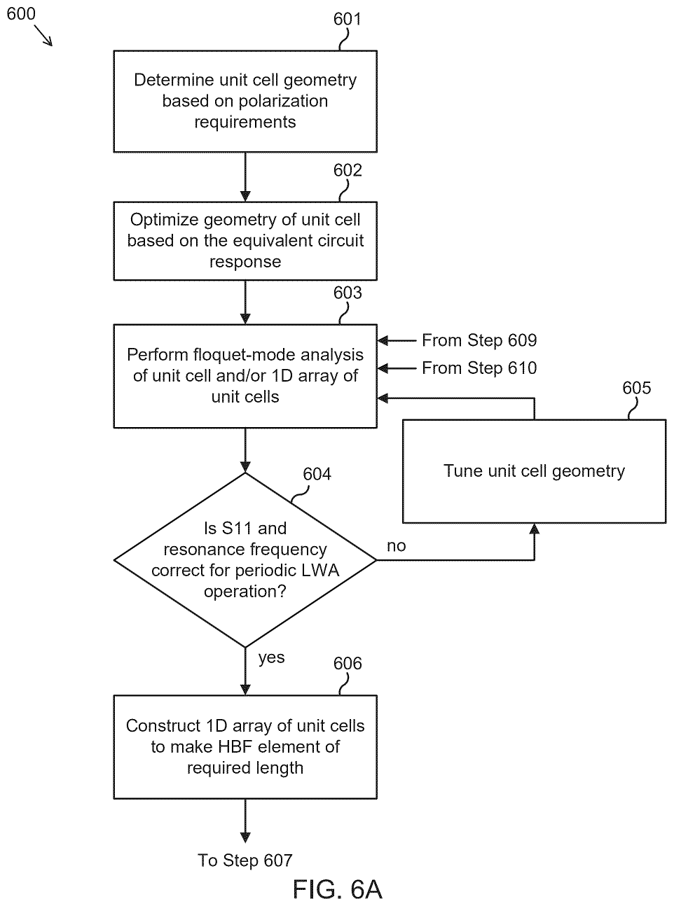

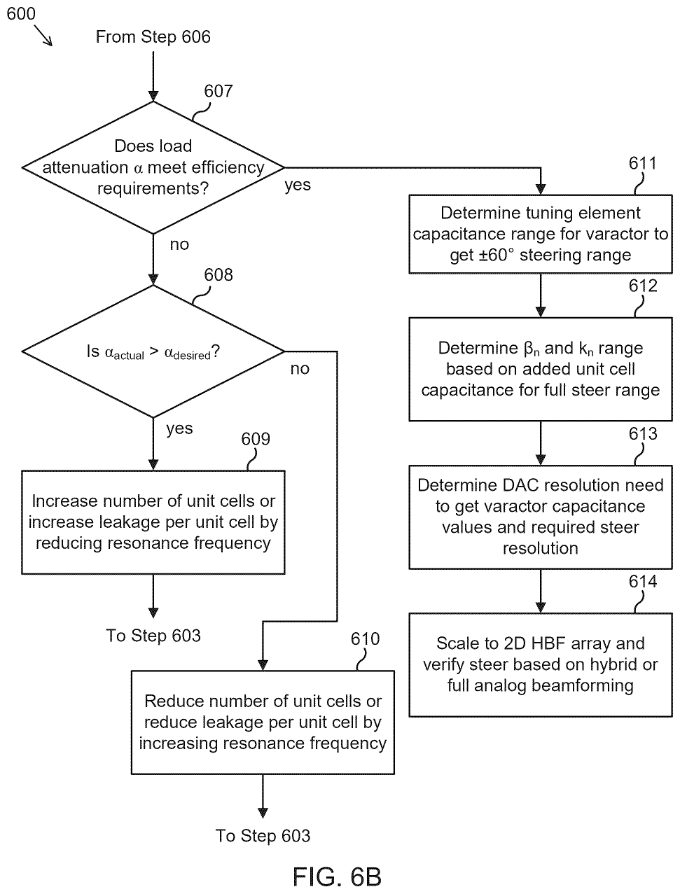

FIGS. 6A and 6B collectively illustrate an example procedure 600 for designing a holographic beamforming antenna array according to embodiments of the present disclosure. This example is for illustration only and other embodiments can be used without departing from the scope of the present disclosure.

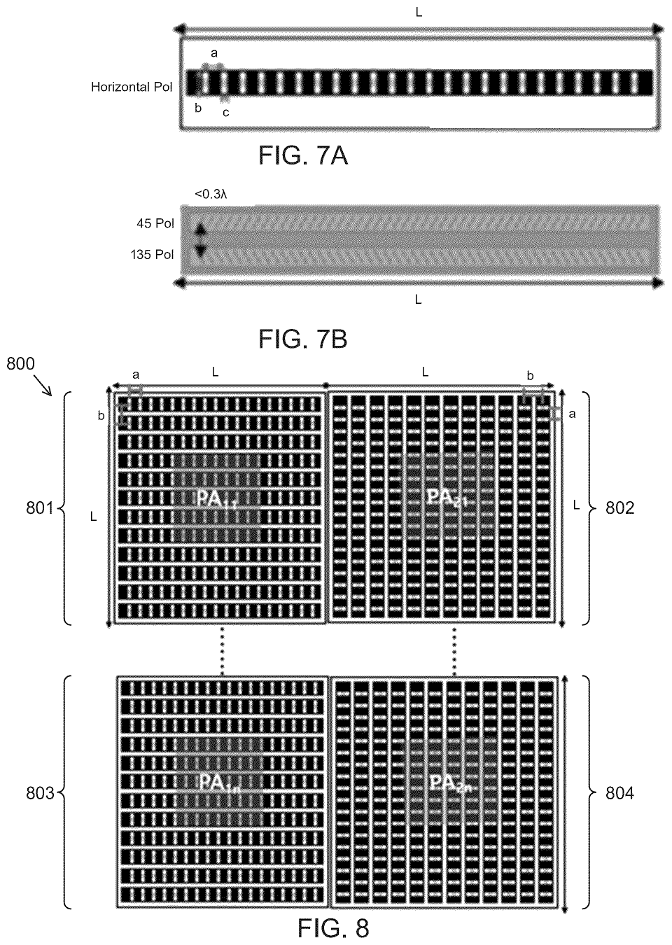

The procedure 600 begins with determining a unit cell geometry based on polarization requirements (step 601). Depending on type of polarization needed, the unit cell may employ single polarization, horizontally polarized antenna of the type depicted in FIG. 7A. FIG. 7A illustrates a 1D array of single polarization, horizontally polarized antenna unit cells, each having separation a from adjoining unit cells, slot length b, and slot width c within a microstrip line having length L. Each vertically oriented slot on the horizontal microstrip line for the unit cell produces the horizontal polarization. The unit cell may alternatively employ dual polarization 45/135 polarized antennas of the type depicted in FIG. 7B. FIG. 7B illustrates two 1D arrays: one on top, in which the slot in the horizontal microstrip line is rotated by +45° to produce 45° polarization, and one on the bottom, in which the slot in the horizontal microstrip line is rotated by +135° to produce 135° polarization. In this case, multiple unit cells of same 45° rotated orientation arranged periodically will occupy one holographic beamforming antenna array element. That array of multiple unit cells can be vertically stacked with another holographic beamforming antenna array element having all unit cells rotated by 135° and arranged periodically. In case of the 45/135 polarized antenna, the individual rows of different polarizations of each holographic beamforming antenna array element have less than 0.3λ spacing, to ensure that individual rows of same polarization have less than 0.6λ 2 spacing and thereby ensure elevation domain steering without grating lobes. Depending on the length L of the element, multiple holographic beamforming antenna array elements can be stacked even in azimuth direction for full array design.

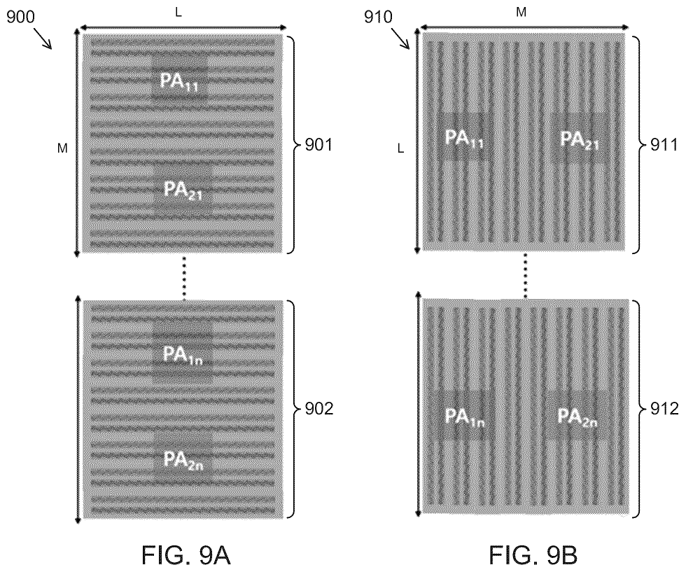

Referring back to FIGS. 6A and 6B, once the unit cell geometry is determined, the geometry of the unit cell is optimized based on the equivalent circuit response (step 602). For example, optimization may involve adjusting size and spacing parameters discussed below in connection with FIG. 8, FIG. 9A, or FIG. 9B. Floquet-mode analysis is performed on the unit cell (step 603). For instance, spatial harmonics arising from periodic structures in the unit cell are employed to calculate the radiation pattern and propagation characteristics for the unit cell. A determination is made as to whether the S11 reflection coefficient and resonance frequency for the unit cell design are correct for periodic leaky wave antenna operation (step 604). The S11 reflection coefficient may be used to measure the amount of radio frequency signal reflected back from the antenna when fed, indicating how efficiently the antenna radiates energy instead of reflecting that energy back towards the source. Generally, a low S11 value is desirable for a good leaky wave antenna design. If the S11 reflection coefficient and resonance frequency are not correct for periodic leaky wave antenna operation, the unit cell geometry is tuned (step 605), and Floquet-mode analysis is performed on the tuned unit cell geometry.

If the S11 reflection coefficient and resonance frequency are correct for periodic leaky wave antenna operation, a 1D array of the unit cells are constructed to make a holographic beamforming antenna element of the required length (step 606). A determination is made of whether the load attenuation a for the ID array of unit cells meets one or more efficiency requirements (step 607). If not, a determination is made of whether the actual load attenuation α_{actual} is greater than (or less than) the desired load attenuation α_{desired} (step 608). If the actual load attenuation is greater than the desired load attenuation, the number of unit cells is increased, or the leakage per unit cell is increased by reducing the resonance frequency (step 609). If the actual load attenuation is not greater than the desired load attenuation, the number of unit cells is reduced, or the leakage per unit cell is reduced by increasing the resonance frequency (step 610). Following either adjustment, floquet-mode analysis of the design is again performed.

Once the load attenuation meets the one or more efficiency requirements, a determination is made of the tuning element capacitance range for a varactor that is needed to obtain a +60° steering range for the propagated beam (step 611). A determination is also made of the propagating wave phase constant Bn and the wavenumber kₙ range(s), based on the added unit cell capacitance introduced by the varactor, for full steering range (step 612). A further determination is made of the digital-to-analog converter resolution needed to obtain the varactor capacitance values and required steer resolution (step 613). The ID array of unit cells is then scaled to a two-dimensional holographic beamforming antenna array (step 614). Suitable two-dimensional designs are described below in connection with FIG. 8, FIG. 9A, and FIG. 9B. Beam steering using the two-dimensional array is also verified based on hybrid (digital and analog) beamforming or full analog beamforming.

Although FIGS. 6A and 6B illustrate one example of a process for designing a holographic beamforming antenna array, various changes may be made to FIGS. 6A and 6B. For example, while shown as a series of steps, various steps in FIGS. 6A and 6B could overlap, occur in parallel, occur in a different order, or occur any number of times (including zero times).

Based on the single polarization or dual polarization holographic beamforming element design, the finite array can have different number of radio frequency (RF) chains for full analog beamforming, or hybrid analog and digital beamforming. The key difference between single polarization or dual polarization designs is the direction of analog steer. For a single polarization holographic beamforming design, the second polarization is obtained by rotating the entire panel as shown in FIG. 8.

FIG. 8 illustrates a dual polarization holographic beamforming antenna array design 800 according to embodiments of the present disclosure. The embodiment illustrated in FIG. 8 is for illustration only, and variants could have the same or similar configuration. FIG. 8 does not limit the scope of this disclosure to any particular implementation of a dual polarization holographic beamforming antenna array.

In FIG. 8, dual polarization is achieved by tiling and rotating single polarization units. As apparent, each antenna panel 801 through 804 is formed of an array of the 1D, single polarization, horizontally polarized antenna unit cells of the type depicted in FIG. 7A, each with slot separation a, inter-element spacing b, and element length L. In the example illustrated, there are a total 2n antenna panels (of which four antenna panels 801 through 802 are shown) with overall area of nL×2L. Each antenna panel 801, 803 in which the microstrip lines forming the antenna element array are oriented in a first direction has a counterpart antenna panel 802, 804 in which the microstrip lines forming the antenna element array are oriented is a second direction rotated 90° relative to the first direction. The antenna panels 801, 803 on the left support horizontal polarization with multiple holographic beamforming elements stacked in the vertical direction; the antenna panels 802, 804 on the right support vertical polarization with multiple holographic beamforming elements stacked in the horizontal direction. That is, tiles can be rotated to generate vertical polarization and stacked besides the horizontal polarization tiles.

A single power amplifier drives each antenna panel 801 through 804. Each antenna panel 801 through 804 is fed by power amplifier PA_{ab}, where a denotes polarization and b denotes the panel number (e.g., α=1 denotes horizontal polarization and a32 2 denotes vertical polarization). Hence PA₁₁ corresponds to the power amplifier feeding antenna panel 801 having horizontal polarization, while PA₂₁ corresponds to the power amplifier feeding antenna panel 802 having vertical polarization. As evident, fewer power amplifiers are required than for the design in (for example) FIG. 14.

One drawback for such an architecture is steering asymmetry. Even assuming full analog beam steering for both the horizontal polarization antenna panels 801, 803 and the vertical polarization antenna panels 802, 804, the horizontal spacing is a and vertical spacing is b for the antenna panels 801, 803, whereas the horizontal spacing is b and the vertical spacing is a for the antenna panels 802, 804. The spacing a is the spacing between unit cells of the same holographic beamforming element, which is typically around 0.1λ-0.15λ, whereas the spacing b is the spacing between holographic beamforming elements, which is typically around 0.25λ-0.3λ. Since the value for a is typically half of the value for b, there are differences between azimuth and elevation steering, creating an asymmetry between vertical and horizontal polarizations.

Another disadvantage of the dual polarization holographic beamforming antenna array design 800 is the use of 2×panel area to support dual polarization and, therefore, both azimuth and elevation beam steering between the two polarizations (even if asymmetrically).

FIGS. 9A and 9B illustrate two alternative dual polarization holographic beamforming antenna array designs 900, 910 according to embodiments of the present disclosure. The embodiments illustrated in FIGS. 9A and 9B are for illustration only, and variants could have the same or similar configuration. FIGS. 9A and 9B do not limit the scope of this disclosure to any particular implementation of a dual polarization holographic beamforming antenna array.

In each of FIGS. 9A and 9B, dual polarization is implemented using 45/135 holographic beamforming elements in a row configuration. As apparent, each antenna panel 901 and 902 in FIG. 9A and each antenna panel 911, 912 in FIG. 9B is formed of sets of the 45°/135° polarized antenna unit cells of the type depicted in FIG. 7B. Each antenna panel 901 and 902 and each antenna panel 911 and 912 uses dual orthogonal polarizations at 45° and 135° having length L and panel width M. In the dual polarization holographic beamforming antenna array designs 900, 910, both polarizations have similar beam steering in azimuth and elevation directions. In the azimuth direction, the steering range is increased due to smaller grating lobes owing to very small unit cell spacing. In elevation direction, the steering range and side lobe levels (SLL) resemble a conventional phased array system with 0.5λ-0.7λspacing between phase centers of the elements.

In some embodiments, individual L×M tiles are oriented for enhanced beam steering in the elevation direction (i.e., rotated relative to the orientation shown in FIG. 9A). In these cases, the overall antenna panel resembles that shown in FIG. 9B, with the overall antenna panel size determining antenna gain.

Typically, without tuning elements, the holographic beamforming antenna designs of FIGS. 9A and 9B can have radiation efficiencies of >80% and aperture efficiencies of >60%. Tuning elements like pin diodes and varactors produce loss, which is dependent on the quality factor of the tuning element (where quality factor often deteriorates with frequency). At low frequency solutions for the FRI band at around 3 giga-Hertz (GHz), the loss from tuning elements can be less than 0.5 dB. At higher operating frequencies in the FR2 band around 28 GHz, the overall varactor losses can be as high as 1 dB-2 dB. Improving the varactor quality factor and tailoring the varactors for specific frequency applications can help to reduce loss and improve the overall efficiency.

For increasing the EIRP of a base station, there are approaches:
1. The length/of the holographic beamforming element may be increased to increase the antenna gain.
2. More L×M tiles may be stacked, which results in larger antenna panel size and proportionally larger number of power amplifiers.
3. The number of holographic beamforming rows in each tile may be reduced. Reducing tile length from M to M1 results in same antenna panel size, but with more power amplifiers. For example if M1=M/2, the total number of power amplifiers in each panel increases from 2n to 4n, thereby giving 3 dB higher EIRP.

With the designs of FIGS. 9A and 9B, the antenna panel size for same 2n PAs is approximately half of the overall size for panel in FIG. 8. The same notation for power amplifier PA_{ab}, may be employed, with a denoting polarization and b denoting the panel number (e.g., a=1 denotes 45° polarization and a=2 denotes 135° polarization). Two power amplifiers PA₁₁ and PA₂₁ are required for antenna panel 901 or antenna panel 911, and two power amplifiers PA₁ₙ and PA₂ₙ are required for antenna panel 902 or antenna panel 912.

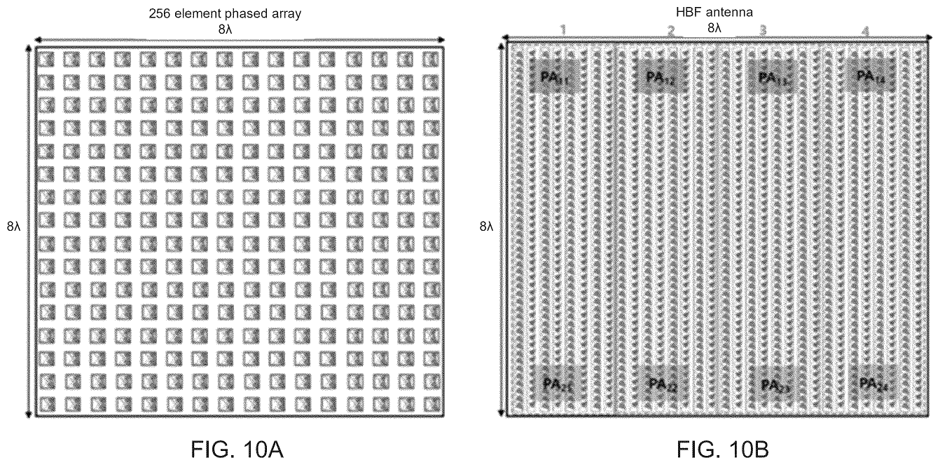

The reduction in number of power amplifiers used in holographic beamforming antenna array as compared to traditional phased arrays can be clearly seen from FIG. 8 and FIGS. 9A and 9B, as compared to FIG. 14. As an example, comparing a 16×16 phased array with a same size of holographic beamforming antenna using I=8λ holographic beamforming element length and M=2λ which means that each holographic beamforming tile has four holographic beamforming column-based elements and there are four total tiles in the antenna panel. FIGS. 10A and 10B illustrate the comparison. FIG. 10A shows a phased array having 256 dual polarization antenna elements and 512 total power amplifiers (including both polarizations). FIG. 10B shows a holographic beamforming antenna having only eight total power amplifiers, which is a 64×reduction. (Since the holographic beamforming unit cell is small compared to the overall antenna panel size, each unit cell is represented by an arrow showing polarization direction in FIG. 10B). Assuming each phased array power amplifier is driven by 4 decibel-milliwatt (dBm) radio frequency output power and has 3.6% direct current (DC)-to-RF power efficiency, the 256-element antenna panel of FIG. 10A can provide 60 dBm EIRP by consuming 36 watts (W) of DC power.

The holographic beamforming panel of FIG. 10B, on the other hand, can use high power gallium nitride/gallium arsenide (GaN/GaAs) power amplifiers, which can provide 24 dBm output power per power amplifier at 15% DC-to-RF power efficiency. The change in power amplifier design is enabled because the larger footprint of each power amplifier is possible based on the reduction in the number of power amplifiers. Also, since the reduction in power amplifier number is 64×, even if the high-power power amplifiers have 64× more cost, overall cost can be the same as low-cost CMOS power amplifiers commonly used in the phased array. Using a holographic beamforming architecture such the example in FIG. 10B, more than 50% lower DC power is consumed for same EIRP, as shown in TABLE 1:

TABLE 1

| Base Station Parameter | unit | Phased Array | HBF |
|---|---|---|---|
| Number of elements | # | 25 | 16 |
| Number of unit cells per HBF element | # | | 64 |
| Antenna gain per panel | dBi | 29 | 28 |
| Additional loss | dB | 0 | 1 |
| Final antenna gain per panel | dBi | 29 | 27 |
| Sub-array dim | # | 1 | 4 |
| Number of RF chains per panel per pol | # | 256 | 4 |
| Transmit power per chain | dBm | 4 | 24.1 |
| Transmit power per chain | mW | 2.512 | 257.040 |
| Number of panels | # | 1 | 1 |
| Total RF transmit power per pol | dBm | 28.1 | 30.1 |
| Total RF transmit power per pol | W | 0.643 | 1.028 |
| TX EIRP per pol | dBm | 57.1 | 57.1 |
| Pol multiplier | | 2 | 2 |
| TX EIRP total | | 60.1 | 60.1 |
| Power added efficiency | % | 3.6 | 15 |
| DC draw for RF | W | 35.7 | 13.7 |
| HBF controller per panel | W | 0 | 2.9 |
| HBF controller total | | 0 | 2.9 |
| Total DC power | W | 35.7 | 16.6 |
| RX antenna gain | dBi | 29.00 | 27.00 |
| Overall panel size | | 8λ(V) × 8λ(H) (2P) | 8λ(V) × 8λ(H) (2P) |
| Overall area | | 64λ² (2P) | 64λ² (2P) |

For purposes of comparison, the holographic beamforming antenna gain is conservatively assumed to be 2 dB lower than the phased array antenna while occupying the same area. This assumption corresponds to lower directivity of a holographic beamforming antenna and losses from tuning elements. In spite of the lower antenna gain, superior DC power efficiency can be seen. The architecture can be easily scaled to offer higher EIRP solutions if needed for improved coverage while maintaining smaller number of highly efficient power amplifiers.

TABLE 1 corresponds to one example architecture and power consumption. By changing the architecture and scaling the design for higher EIRP or operation at a different frequency, the power consumption gains can be better or worse.

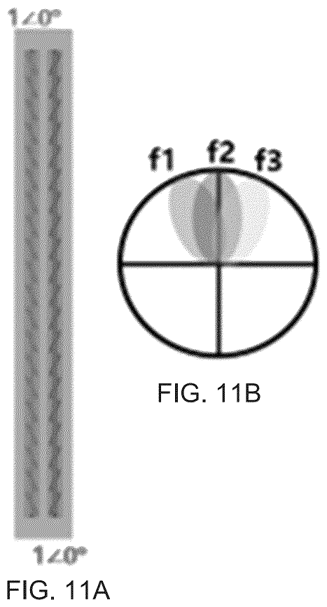

The holographic beamforming antenna also has another important feature: frequency spreading. According to equation (1), k_{x,0} and kₓₙ are wavenumbers that are frequency dependent. However, the additional factor of π2mn/p is a fixed value independent of frequency and only related to the periodicity and number of unit cells. As a result, the delay along the holographic beamforming element as the travelling wave propagates is different for different frequencies. That delay is a function of the unit cell geometry, which determines the wavenumber, and the periodicity of the unit cell, which is determined by the spacing and efficiency requirements that dictate the attenuation. Hence at any frequency fₙ, the travelling wave is a faster wave if fₙ>fₙ₋₁. This leads to a larger delay along the line and tilts the beam to the right. An illustration for a generic holographic beamforming element is shown in FIG. 11A and the resulting radiation pattern for three frequencies such that f₃>f₂>f₁ is shown in FIG. 11B. The radiation patterns show a frequency spread in the elevation direction when a holographic beamforming column-based element is implemented.

The frequency spread in FIG. 11B is fixed and cannot be controlled in real time. While delay spreads aid in user mobility application problems of the type discussed above, non-tunability restricts usefulness for enhancing coverage during mobility. Some architectures of holographic beamforming, however, are compatible with JPTA-based approaches that can enable tunable frequency spreading.

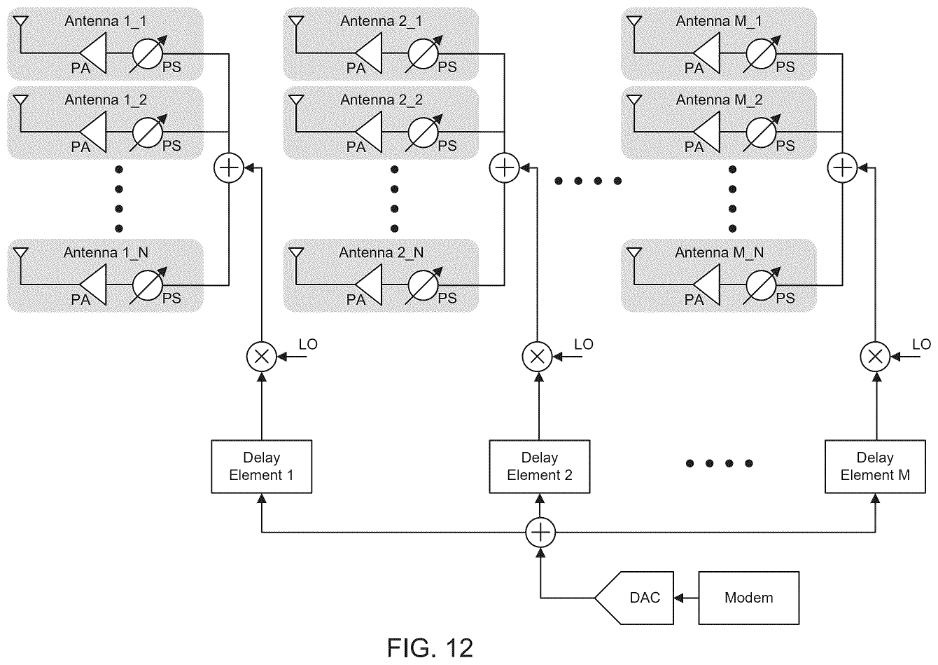

FIG. 12 illustrates a block diagram for a generalized JPTA antenna panel in transmitting mode. During a receive operation, the architecture is similar except that the power amplifier is replaced by a low noise amplifier, and the digital-to-analog converter (DAC) is replaced by an analog-to-digital converter (ADC). The description below will focus on the exemplary transmitter architecture, but similar practices are also applicable for the receive chain.

The architecture in FIG. 12 uses antenna elements 1_1 through M_N each with a phase shifter (PS) and a power amplifier (PA). The antenna elements are combined in a vertical direction (i.e., antenna elements 1_1 through 1_N, antenna elements 2_1 through 2_N, through antenna elements M_1 through M_N) with one local oscillator (LO) after a delay element. These vertical elements are combined to generate beam spread for azimuth direction beamforming, since each column of antenna elements has a different delay. In FIG. 12, there are totally M×N antenna elements in the array. With phased-array antenna, each of the M×N antennas have an associated power amplifier and phase shifter. The baseband signal is digital as generated by the modem. The digital signal is converted to analog intermediate frequency (IF) signals using a DAC. The multiplexer divides the signal into M identical output signals. M delay elements act on each of the output signal using delay values similar to those in the structure of FIG. 14. The individual signals are converted to RF signals using a local oscillator. Each RF signal then passes through the corresponding phase shifter and power amplifier and is input to the antenna element

To generate viable beam spreading when replacing traditional antenna elements with holographic beamforming elements, maintaining column-to-column spacing of 0.5λ for a JPTA system behavior similar to that in FIG. 12 is necessary. To enable a holographic beamforming architecture compatible with JPTA, the length of each tile M in FIG. 9A or FIG. 9B is reduced to 0.5λ. As discussed above, a holographic beamforming architecture reduces the number of power amplifiers. Advantages of using a holographic beamforming architecture for JPTA are further evident by the reduction in the number of phase shifters and multiplexers.

FIG. 13 depicts a dual polarization holographic beamforming antenna architecture for use with joint phased time array operation in accordance with this disclosure. The embodiment illustrated in FIG. 13 is for illustration only, and variants could have the same or similar configuration. FIG. 13 does not limit the scope of this disclosure to any particular implementation of a dual polarization holographic beamforming antenna architecture.

In FIG. 13, the full JPTA transmit block is only shown for one polarization; only the power amplifiers for the other transmit block chain is depicted, but those skilled in the art will understand that the full structure is replicated for the other polarization.

The total size of the generic phased array in FIG. 12, with M×N antenna elements, is (M/2)/2)λ×(N/2)λ. To match those dimensions for the holographic beamforming antenna design of FIG. 13 is assumed to have a length of (N/2)λ. Using this length and 0.5λ tile size, M tiles in total are required to conform to the overall antenna size.

TABLE 2 compares the total active front-end components in the generic phased-array JPTA architecture of FIG. 12 versus the holographic beamforming JPTA architecture of FIG. 13:

TABLE 2

| Components | unit | Phased Array | HBF |
|---|---|---|---|
| Panel size | | (N/2)λ × (M/2)λ | (N/2)λ × (M/2)λ |
| Number of power amplifiers per polarization | # | N × M | M |
| Number of phase shifters per polarization | # | N × M | M |
| Number of multiplexers per polarization | # | M + 1 | 1 |
| Number of local oscillators per polarization | # | M | M |
| Number of delay elements per polarization | # | M | M |
| Polarization multiplier | # | 2 | 2 |
| Total active elements | # | 2*(2*N*M + 3M + 1) | 2*(4M + 1) |

As seen in TABLE 2, there is a significant reduction in number of active elements using the holographic beamforming approach. The present disclosure's holographic beamforming architecture for JPTA operation has a fixed beam spreading effect in elevation direction due to nature of leaky wave operation and a tunable beam spreading in azimuth direction due to JPTA operation. This differs from the traditional phased array case, which has no beam squint or spreading in the elevation direction and JPTA based beam-spreading behavior in the azimuth direction. The fixed beam spreading of holographic beamforming results in beam squinting effects in elevation direction, which should be controlled so as to not compromise JPTA operation in azimuth direction.

FIG. 13 is depicted using the dual polarization holographic beamforming antenna array design of FIG. 9B. Those skilled in the art will recognize that similar connection of JPTA transmit blocks may alternatively be connected to the dual polarization holographic beamforming antenna array design of FIG. 9A, or to the dual polarization holographic beamforming antenna array design of FIG. 8.

Any of the above variation embodiments can be utilized independently or in combination with at least one other variation embodiment. The above flowchart illustrates example methods that can be implemented in accordance with the principles of the present disclosure and various changes could be made to the methods illustrated in the flowchart herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A method comprising:
constructing a one-dimensional array of a number of unit cells each having unit cell layout with a resonance frequency meeting a requirement for leaky wave antenna operation of a dual polarized holographic beamforming antenna;
determining that a load attenuation for the one-dimensional array meets one or more efficiency requirements;
determining one or more parameters including capacitance for achieving a desired beamforming steering range and a desired beamforming steering resolution with the one-dimensional array; and
scaling the one-dimensional array to form a two-dimensional, dual polarized holographic beamforming antenna.

2. The method of claim 1, wherein constructing a one-dimensional array of a number of unit cells each having unit cell layout with a resonance frequency meeting a requirement for leaky wave antenna operation of a dual polarized holographic beamforming antenna further comprises:
performing a Floquet-mode analysis of the unit cell layout; and
tuning a geometry of the unit cell layout.

3. The method of claim 1, wherein determining that a load attenuation for the one-dimensional array meets the one or more efficiency requirements further comprises:
changing at least one of the number of the unit cells in the one-dimensional array or a leakage by each of the unit cells to meet the one or more efficiency requirements.

4. The method of claim 1, wherein the unit cell layout comprises a vertical slot in a horizontal microstrip line, and wherein scaling the one-dimensional array to form a two-dimensional, dual polarized holographic beamforming antenna further comprises:
forming a first two-dimensional array with the vertical slot oriented in a first direction; and
forming a second two-dimensional array with the vertical slot oriented in a second direction perpendicular to the first direction.

5. The method of claim 1, wherein the unit cell layout comprises a first array of slots in a first horizontal microstrip line oriented at 45° and a second array of slots in a second horizontal microstrip line oriented at 135°, and wherein scaling the one-dimensional array to form a two-dimensional, dual polarized holographic beamforming antenna further comprises:
replicating the first array of slots and the second array of slots in a regular pattern.

6. The method of claim 1, wherein determining the one or more parameters including capacitance for achieving a desired beamforming steering range and a desired beamforming steering resolution with the one-dimensional array further comprises:
determining a capacitance for a capacitive tuning element.

7. The method of claim 1, wherein determining the one or more parameters including capacitance for achieving a desired beamforming steering range and a desired beamforming steering resolution with the one-dimensional array further comprises:
determining digital-to-analog (DAC) resolution required to obtain the desired beamforming steering resolution.

8. An apparatus comprising:
a first holographic beamforming antenna element having a first polarization, the first holographic beamforming antenna element comprising a linear array of two or more first holographic beamforming unit cells;
a second holographic beamforming antenna element having a second polarization different than the first polarization, the second holographic beamforming antenna element comprising a linear array of two or more second holographic beamforming unit cells;
a single first power amplifier configured to amplify signals to each of the first holographic beamforming unit cells within the first holographic beamforming antenna element; and
a single second power amplifier configured to amplify signals to each of the second holographic beamforming unit cells within the second holographic beamforming antenna element,
wherein the first holographic beamforming antenna element and the second holographic beamforming antenna element are configured to transmit separate beams.

9. The apparatus of claim 8, wherein
the first holographic beamforming unit cells each have a slot transverse to a length of the first holographic beamforming antenna element,
the second holographic beamforming unit cells each have a slot transverse to a length of the second holographic beamforming antenna element, and
an orientation of the first holographic beamforming antenna element is rotated relative to an orientation of the second holographic beamforming antenna elements.

10. The apparatus of claim 9, wherein the first holographic beamforming antenna element comprises N of the first holographic beamforming unit cells and the second holographic beamforming antenna element comprises N of the second holographic beamforming unit cells, the apparatus further comprising:
a first antenna tile comprising the first holographic beamforming antenna element and M−1 holographic beamforming antenna elements each having the first polarization and each comprising N of the first holographic beamforming unit cells; and
a second antenna tile comprising the second holographic beamforming antenna element and M31 1 holographic beamforming antenna elements each having the second polarization and each comprising N of the second holographic beamforming unit cells,
wherein the single first power amplifier is configured to amplify signals to each of the first holographic beamforming unit cells within the first antenna tile, and
wherein the single second power amplifier is configured to amplify signals to each of the second holographic beamforming unit cells within the second antenna tile.

11. The apparatus of claim 8, wherein
the first holographic beamforming unit cells each have a slot oriented at 45° relative to a length of the first holographic beamforming antenna element,
the second holographic beamforming unit cells each have a slot oriented at 135° relative to a length of the second holographic beamforming antenna element, and
an orientation of the first holographic beamforming antenna element is the same as an orientation of the second holographic beamforming antenna elements.

12. The apparatus of claim 11, wherein the first holographic beamforming antenna element comprises N of the first holographic beamforming unit cells and the second holographic beamforming antenna element comprises N of the second holographic beamforming unit cells, the apparatus further comprising:
an antenna panel comprising
the first holographic beamforming antenna element and M−1 additional holographic beamforming antenna elements each having the first polarization and each comprising N of the first holographic beamforming unit cells, and
the second holographic beamforming antenna element and M−1 holographic beamforming antenna elements each having the second polarization and each comprising N of the second holographic beamforming unit cells,
wherein holographic beamforming antenna elements having the first polarization are alternated on the antenna panel with holographic beamforming antenna elements each having the second polarization.

13. The apparatus of claim 12, wherein the holographic beamforming antenna elements having the first polarization have 0.5λ-0.7λ spacing from the holographic beamforming antenna elements each having the second polarization on the antenna panel, where λ is a wavelength of a radio frequency signal transmitted by the antenna panel.

14. The apparatus of claim 8, further comprising:
a joint phased time array transmit circuit including the single first power amplifier and the single second power amplifier.

15. An apparatus comprising:
a joint phased time array transmit circuit including a first power amplifier, a second power amplifier, a first delay element, and a second delay element, wherein the first power amplifier is configured to amplify a single first signal based on an output of the first delay element and the second power amplifier is configured to amplify a single second signal based on an output of the second delay element;
a first holographic beamforming antenna element having a first polarization, the first holographic beamforming antenna element comprising a linear array of two or more first holographic beamforming unit cells each configured to receive the single first signal; and
a second holographic beamforming antenna element having a second polarization different than the first polarization, the second holographic beamforming antenna element comprising a linear array of two or more second holographic beamforming unit cells each configured to receive the single second signal,
wherein the joint phased time array transmit circuit is configured to transmit a plurality of separate beams using the first holographic beamforming antenna element and the second holographic beamforming antenna element.

16. The apparatus of claim 15, wherein the joint phased time array further comprises:
a first signal mixer and a first phase shifter coupled between the first delay element and the first power amplifier; and
a second signal mixer and a second phase shifter coupled between the second delay element and the second power amplifier.

17. The apparatus of claim 15, wherein
the first holographic beamforming unit cells each have a slot transverse to a length of the first holographic beamforming antenna element, the second holographic beamforming unit cells each have a slot transverse to a length of
the second holographic beamforming antenna element, and
an orientation of the first holographic beamforming antenna element is rotated relative to an orientation of the second holographic beamforming antenna elements.

18. The apparatus of claim 17, wherein the first holographic beamforming antenna element comprises N of the first holographic beamforming unit cells and the second holographic beamforming antenna element comprises N of the second holographic beamforming unit cells, the apparatus further comprising:
a first antenna tile comprising the first holographic beamforming antenna element and M−1 holographic beamforming antenna elements each having the first polarization and each comprising N of the first holographic beamforming unit cells; and
a second antenna tile comprising the second holographic beamforming antenna element and M−1 holographic beamforming antenna elements each having the second polarization and each comprising N of the second holographic beamforming unit cells,
wherein the single first power amplifier is configured to amplify signals to each of the first holographic beamforming unit cells within the first antenna tile, and
wherein the single second power amplifier is configured to amplify signals to each of the second holographic beamforming unit cells within the second antenna tile.

19. The apparatus of claim 15, wherein
the first holographic beamforming unit cells each have a slot oriented at 45° relative to a length of the first holographic beamforming antenna element,
the second holographic beamforming unit cells each have a slot oriented at 135° relative to a length of the second holographic beamforming antenna element, and
an orientation of the first holographic beamforming antenna element is the same as an orientation of the second holographic beamforming antenna elements.

20. The apparatus of claim 19, wherein the first holographic beamforming antenna element comprises N of the first holographic beamforming unit cells and the second holographic beamforming antenna element comprises N of the second holographic beamforming unit cells, the apparatus further comprising:
an antenna panel comprising
the first holographic beamforming antenna element and M-1 additional holographic beamforming antenna elements each having the first polarization and each comprising N of the first holographic beamforming unit cells, and
the second holographic beamforming antenna element and M-1 holographic beamforming antenna elements each having the second polarization and each comprising N of the second holographic beamforming unit cells,
wherein holographic beamforming antenna elements having the first polarization are alternated on the antenna panel with holographic beamforming antenna elements each having the second polarization.
